(19) United States
(12) Patent Application Publication
(10) Pub. No.: US 2026/0181290 A1
(43) Pub. Date: Jun. 25, 2026

(54) Dynamic Programming Using a Shortest-Path Solution on a Directed Acyclic Graph for Channel Planning with Select Transmission Modes in an Optical Link

(71) Applicant: Ciena Corporation, Hanover, MD (US)

(72) Inventor: Maria Ilkova Dosseva, Sainte-Adèle (CA)

(73) Assignee: Ciena Corporation, Hanover, MD (US)

(21) Appl. No.: 18/989,175

(22) Filed: Dec. 20, 2024

(51) Int. Cl. H04Q 11/00; H04J 14/02

(52) U.S. Cl. CPC H04Q 11/0062; H04J 14/02762; H04Q 2011/0073; H04Q 2011/0086

(57) ABSTRACT

Systems and methods for dynamic programming using a longest-path solution for channel planning with select baud rates in an optical link include determining a max bit rate table for an optical link based on a provided effective signal-to-noise ratio (ESNR) curve and a Required Effective Signal-to-Noise Ratio (ReSNR) lookup table for that given optical link; constructing a solution graph that encodes possible channel plans for the transmitters and receivers over the optical span, wherein the solution graph includes vertices that represent a possible state and each edge represents a viable transition between states, weighted by a negative capacity gained for the selection of that transition, for dynamic programming; and traversing the solution graph to find a solution for a channel plan on the optical link.

### FIELD OF THE DISCLOSURE

The present disclosure relates generally to optical networking. More particularly, the present disclosure relates to systems and methods for dynamic programming using a shortest-path solution of a directed acyclic graph (DAG) for channel planning with select transmission modes in an optical link.

### BACKGROUND OF THE DISCLOSURE

Maximizing the capacity of an optical link in an optical network within a limited spectrum can be achieved by scheduling optical channels with different transmission modes. Higher baud rate channels consume more spectrum but carry more data, while lower baud rate channels use less spectrum and are suitable for links with signal quality or distance constraints. Dynamic scheduling of these channels allows for better spectrum utilization and increased total capacity. However, scheduling must meet several constraints, such as power levels, guard bands, and modulation formats. While there are numerous possible channel plans that could maximize capacity, it is impractical to generate and evaluate every option in order to uncover one such maximal channel plan. Listing all possible plans would require too much memory, and iterating through each would take too long, making it difficult to find the plan that achieves the global maximum capacity. This creates a challenge in identifying the optimal channel plan efficiently. Conventionally, algorithms and heuristics are used to explore the solution space without examining every configuration, balancing spectrum usage with computational complexity and time. While these conventional approaches yield solutions, they are non-optimal as they do not explore the entire solution space.

### BRIEF SUMMARY OF THE DISCLOSURE

The present disclosure relates to systems and methods for dynamic programming using a shortest-path solution over a DAG for channel planning with select transmission modes in an optical link. In particular, the present disclosure includes an approach to encode every possible solution (whether optimal or not) compactly in a graph to enable the use of dynamic programming (DP). By encoding every possible solution compactly (whether optimal or not) as all possible st-paths within a graph, the DP solution is able to find the provably optimal solution, making the best use of all the bandwidth available. In testing, the present disclosure results in about 2% improved capacity compared to a Monte-Carlo. Additionally, the graph encoding used by the DP solution offers a transparent, deterministic step-by-step view of the process by which this optimal solution is selected, such as using the classic shortest-path algorithm Bellman-Ford, which is well understood. The DP solution is also able to adapt to the additional constraint of handling limiting the number of multiplexers available, thereby being more useful to customers when looking to find an optimal schedule given specific, limited resources currently available. Finally, it is worth noting that while the DP solution does take significantly longer to run than the other algorithms, it also adapts very well to parallelization. This can then also be exploited to produce the latest-so-far best solution, thus adapting the DP algorithm to an approximation version. While this approximation version does not guarantee the same provable optimality, it has been shown in test cases using only 10% of the full graph construction to produce the optimal solution 98% of the time, and in the remaining 2% it achieved at least 99% of the possible optimal capacity. As stated earlier, the full DP solution produces the provably optimal solution, and thus no better can be done in terms of the resulting capacity.

In various embodiments, the present disclosure includes implementation as a method having steps, via a processing device configured to implement the steps, and as a non-transitory computer-readable medium storing instructions that, when executed, cause one or more processors to implement the steps. The steps include determining a max bit rate table for an optical link based on a provided effective signal-to-noise ratio (ESNR) curve and a Required Effective Signal-to-Noise Ratio (ReSNR) lookup table for that given optical link; constructing a solution graph that encodes possible channel plans for the transmitters and receivers over the optical span, wherein the solution graph includes vertices that represent a possible state and each edge represents a viable transition between states, weighted by a negative capacity gained for the selection of that transition; and traversing the solution graph to find a solution for a channel plan on the optical link.

The traversing can include finding one of a shortest path through the solution graph which represents a channel plan with maximal capacity. The traversing can include finding a shortest path through the solution graph where edges have a negative weight. The traversing can utilize the Bellman-Ford algorithm. The max bit rate table, for the provided ESNR curve and ReSNR table, and any given frequency f and baud rate b, returns the maximum bit rate such that ESNR satisfies a constraint of being greater than ReSNR. The determining the max bit rate table can further include subtracting an ESNR margin from the ESNR curve. The solution graph includes a plurality of vertices, each representing a state of the channel plan, and the solution graph includes an x-axis for frequency, each vertex spaced at a resolution of optical spectrum, and y-axis for ports on multiplexers. The traversing moves left to right to determine the channel plan with a plurality of possible arcs. A last row of the plurality of vertices is spaced apart based on wavelength selective switch (WSS) resolution, and other rows of the plurality of vertices can be spaced apart based on a configured resolution which is independent of the WSS resolution. WSS edges can align to the WSS resolution in the last row.

### BRIEF DESCRIPTION OF THE DRAWINGS

The present disclosure is detailed through various drawings, where like components or steps are indicated by identical reference numbers for clarity and consistency.

FIG. 1 illustrates an example optical link.

FIG. 2 illustrates a graph for defining the spectral occupancy problem.

FIG. 3 illustrates a flowchart of a DP process for determining the maximum capacity.

FIGS. 4-5 illustrate a constructed Max Bit Rate table where FIG. 4 is a graph of Required Effective Signal-to-Noise Ratio (ReSNR), which can be used with an effective signal-to-noise ratio (ESNR) curve from FIG. 2, to provide a resulting Max Bit Rate table as illustrated in the graph in FIG. 5.

FIG. 6 illustrates a graph encoding the solution space for the DP process of FIG. 3.

FIG. 7 illustrates an example operation with a graph illustrating optical spectrum and associated channels based on traversal of a solution graph.

FIG. 8 illustrates a flowchart of a process for dynamic programming using a shortest-path solution over a DAG for channel planning with select transmission modes in an optical link.

FIG. 9 illustrates a block diagram of a processing system.

### DETAILED DESCRIPTION OF THE DISCLOSURE

Again, the present disclosure relates to systems and methods for dynamic programming using a shortest-path solution on a DAG with select transmission modes in an optical link. The shortest-path solution includes the DAG using negative-weighted edges with a shortest-path algorithm, such that the shortest path through the DAG is maximizing the total capacity on an optical link due to the negative-weighted edges.

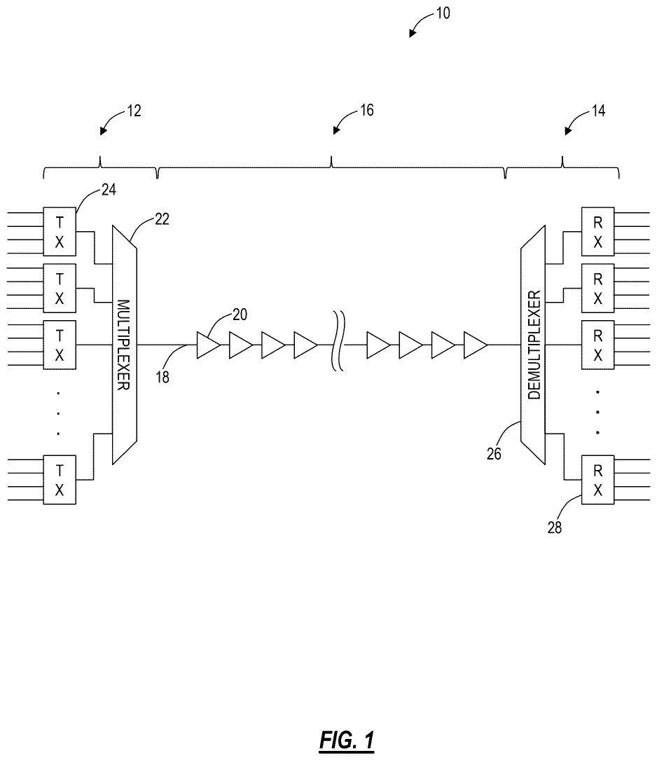

FIG. 1 illustrates an example optical link 10. For illustration purposes, the optical link 10 is shown with a single direction from a first terminal 12 to a second terminal 14. Of course, a practical embodiment will include the opposite direction, more terminals, etc. The optical link 10 can be in a terrestrial network as well as a submarine network, i.e., the channel planning with DP described herein can be used with any optical link. In terrestrial networks, the terminals 12, 14 can be referred to as reconfigurable optical add/drop multiplexers (ROADMs). In submarine networks, the terminals 12, 14 can be referred to as submarine line terminating equipment (SLTE). Generally, the optical link 10 includes an optical span 16 interconnecting the terminals 12, 14. The optical span 16 includes a fiber cable 18, as well as optical amplifiers 20. In a submarine network, the optical span 16 can be referred to as wet plant, and the optical amplifiers 20 as repeaters.

The terminal 12 includes a multiplexer 22 which combines channels at different spectrum locations from transmitters (TX) 24 for transmission over the optical span 16. The terminal 14 includes a demultiplexer 26 which separates the channels to provide to corresponding receivers (RX) 28. In a practical embodiment, a transmitter 24 can be housed with a receiver 26 in an integrated module, i.e., an optical modem. Here, the transmitter 24 at the terminal 12 connects to a corresponding receiver 28 at the terminal 14, and, for bidirectional communication, another transmitter 24 at the terminal 14 (not shown) connects to another corresponding receiver 28 at the terminal 12 (not shown). The transmitters 24 and the receivers 26 (collectively referred to as modems) support variable capacity (bandwidth) through the use of adaptive modulation formats, adjustable baud rates, and efficient spectrum usage.

These modems use coherent optics technology, which allows them to dynamically adjust the signal parameters to suit the specific conditions of the optical span 16, such as distance and quality. By using different modulation formats—such as QPSK (Quadrature Phase Shift Keying), 8QAM (8 Quadrature Amplitude Modulation), 16QAM, 64QAM, etc.—the modems can tradeoff between spectral efficiency and signal reach. Higher-order modulation formats, like 16QAM, 64QAM, etc., provide greater data rates but are more susceptible to noise and are therefore suited for shorter distances, while lower-order modulation formats, like QPSK, are more resilient and ideal for longer distances. In addition to modulation flexibility, the modems can adjust the baud rate, which controls the symbol rate, effectively determining how much data is transmitted per unit time. By adapting the baud rate, the modems can manage channel capacity and optimize for varying network conditions. This ability to modify both modulation formats and baud rates enables dynamic spectrum usage, allowing the system to allocate the right amount of spectrum based on the needs of the traffic and the conditions of the optical path.

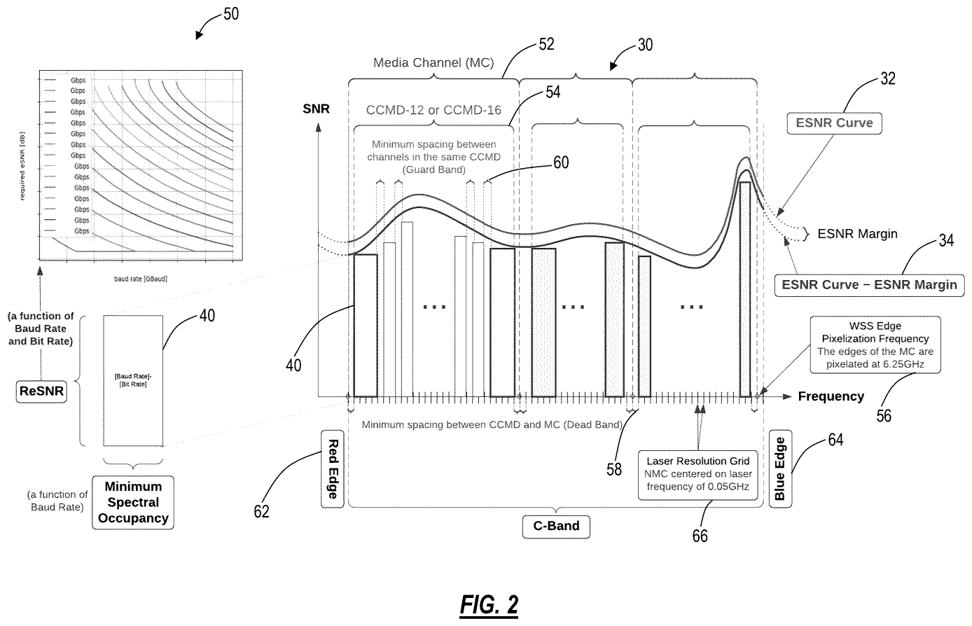

The objective of the present disclosure is how to select the transmitter 24 settings in terms of bit rate, baud rate, modulation format, and spectral occupancy to achieve the maximum bandwidth on the optical link 10. FIG. 2 illustrates a graph 30 for defining the spectral occupancy problem. The graph 30 includes frequency on the x-axis and signal-to-noise ratio (SNR) on the y-axis. The graph 30 illustrates the C-band which spans from about 191.6 THz to 196.1 THz, which corresponds to wavelengths between approximately 1530 nm to 1565 nm. The C-band is particularly favored in optical communications because it offers a low attenuation window in standard single-mode fibers, as well as being well-suited to amplification via erbium doped fiber amplifiers (EDFAs).

The graph 30 includes an effective signal-to-noise ratio (ESNR) curve 32 which represents quality across the optical spectrum. ESNR is a key metric in coherent optical systems, where it quantifies the combined impact of noise, distortions, and impairments on the signal's quality. Unlike a traditional SNR, which measures the ratio of signal power to noise power, ESNR provides a more accurate assessment by incorporating not just the noise but also the signal degradations from various factors like chromatic dispersion, nonlinearities, and other physical impairments. The ESNR curve 32 is typically over the optical spectrum, displaying how the ESNR varies for each channel or wavelength in the optical link 10. A higher ESNR value indicates better signal quality, meaning that more advanced and efficient modulation formats (like 16QAM, 64QAM, etc.) can be used, allowing for higher data rates. Conversely, lower ESNR values may require simpler modulation formats (like QPSK) to maintain reliable communication. In practice, the ESNR curve 32 is used to determine the optimal operational parameters for each channel in a dense wavelength division multiplexing (DWDM) system, ensuring that the available spectrum is utilized efficiently while maintaining high-quality transmission.

The graph 30 also includes an (ESNR curve—ESNR margin) curve 34, and the curve 34 may have the same shape as the ESNR curve 32 with ESNR margin included therein, if the margin is a constant; however, the ESNR margin may also be a non-constant function of frequency, in which case the curve 34 will not have the same shape as the ESNR curve 32. The ESNR margin can be a configurable value, e.g., 0.5 dB. The ESNR margin is a safety buffer that measures how much additional signal degradation can be tolerated before communication becomes unreliable. It ensures network resilience against unexpected impairments like temperature changes or increased noise. A healthy ESNR margin allows for higher-order modulation, increasing data rates, while a low margin may require simpler formats for stability. It also guides future network upgrades and proactive maintenance, ensuring reliability and preventing potential outages by signaling when adjustments or component replacements are needed.

The ESNR curves 32, 34 can vary significantly across different optical links due to several factors, including the length of the fiber, the quality of the fiber, and the specific impairments encountered along each link. For shorter, high-quality optical links with minimal impairments, the ESNR curves 32, 34 tends to be higher and relatively flat across the optical spectrum, indicating consistent signal quality and the potential for higher-order modulation formats to be used across all channels. In contrast, for longer optical links or links that pass through multiple amplifiers 20 and optical components, the ESNR curves 32, 34 typically show more variation, with lower ESNR values across certain wavelengths due to the accumulation of noise, dispersion, and nonlinear effects. The curves 32, 34 may also dip at certain wavelengths due to localized impairments, such as narrowband interference or fiber bends. These variations in the ESNR curves 32, 34 directly influence the choice of modulation formats and transmission rates for each optical link at each spectrum location, with more degraded links requiring more conservative settings to maintain reliable communication.

The graph 30 includes channels 40 (which can also be referred to as signals) which are shown as different height and width rectangles at different locations across the optical spectrum. Each channel is formed by a corresponding transmitter 24 based on settings for frequency, modulation format, baud rate, etc. The spectral occupancy represents how much of the optical spectrum each channel 40 requires, and the width of the rectangle of each channel 40 is a function of baud rate of the transmitter 24. The baud rate directly influences its spectral occupancy, which refers to the amount of bandwidth or spectrum that the signal occupies in the frequency domain. The baud rate, or symbol rate, defines how many symbols are transmitted per second. A higher baud rate results in faster transmission of symbols, but it also increases the signal's bandwidth, leading to greater spectral occupancy. Essentially, as the baud rate increases, the signal requires more spectrum to carry the same amount of data because each symbol contains a fixed amount of information. Conversely, a lower baud rate compresses the signal's spectral footprint but may also reduce the overall data rate. Additionally, the wider channels constructed from higher baud rates require less spectrum dedicated to guard bands, thereby also improving the spectral efficiency; however, they do not fit as well under ESNR curves which are not as flat. Therefore, adjusting the baud rate allows for a trade-off between data capacity and spectral efficiency. Additionally, the wider channels constructed from higher baud rates allow us to not require as many guardbands, thereby also improving the spectral efficiency; however, they don't fit as well under ESNR curves which are not as flat.

The height of each channel 40 is a function of baud rate and bit rate, as determined from the Required Effective Signal-to-Noise Ratio (ReSNR) lookup table 50 in FIG. 2. ReSNR is a measure of a transceiver's noise tolerance, representing the lowest ESNR at which forward error correction (FEC) can still compensate for channel impairments, known as the FEC limit. A lower ReSNR value indicates a stronger transceiver capable of maintaining error-free transmission even in the presence of higher noise levels. The back-to-back ReSNR, determined by sending the transmitter output directly into the receiver while artificially adding noise, serves as a best-case benchmark since it excludes the degradations introduced by optical fibers, amplifiers, and other network components. In practice, the actual ReSNR will likely be higher than this idealized back-to-back value, though sophisticated models can simulate and estimate these values computationally.

The problem can be defined as how to assign channels and at what frequency, baud rate, and bit rate to maximize the bandwidth (total capacity) over the optical spectrum given the ESNR curves 32, 34 in the graph 30 and the ReSNR lookup table 50. The channels 40 can be added onto the optical span 16 at the terminal 12 via media channels 52. A media channel 52 refers to a block of optical spectrum allocated for transmitting high-capacity data between two points, including one or more Network Media Channels (NMCs). These NMCs are individual wavelength channels 40 within the media channel 52, each of which can carry a portion of the total data. The media channel 52 allows for flexible management of bandwidth by adjusting key parameters such as baud rate, modulation format, and channel width to optimize performance and maximize spectral efficiency.

The media channels 52 and associated channels 40 therein are formed by the multiplexer 22. In an embodiment, the multiplexer 22 is referred to as a channel colorless mux/demux (CCMD)-12 or CCMD-16 54. These are specific product implementations of the multiplexer 22, presented for illustration purposes. The CCMD-12 and CCMD-16 54 refer to models with 12 or 16 channels, respectively, allowing them to handle a large number of wavelengths simultaneously. Of course, these 12 or 16 channel multiplexers/demultiplexers are merely presented for illustration purposes and those skilled in the art will recognize the approach described herein can be adapted to any type or port count of the multiplexer 22. These devices dynamically allocate spectrum, adjusting parameters such as channel width, baud rate, and modulation format based on network requirements. By doing so, they help form and manage the media channels 52, This dynamic configuration ensures optimal performance, even as traffic demands fluctuate. For example, if more capacity is needed, the CCMD 54 can widen the media channel 52 by allocating more spectrum and adjusting the baud rate and modulation format to maximize the data rate. Alternatively, for longer distance transmission, the CCMD 54 may narrow the media channel 52 to use a more robust modulation format that can withstand transmission impairments, like fiber attenuation and dispersion, over long distances.

The following describes the solution using example parameters and variables based on the C-band, the CCMDs 54, and the transmitters 24. Those skilled in the art will recognize these parameters and variables are used for illustration purposes, and other embodiments are possible. For example, different multiplexers 22 would have different values, i.e., the CCMDs 54 are one embodiment. In an example embodiment, the margin between adjacent CCMDs 54 is 6.25 GHz (i.e., a dead band 58 which is the minimum spacing between the CCMD 54 and the media channel 52), and between channels 40 within the same CCMD group of 3 GHz (i.e., a guard band 60 which refers to the minimum spacing between channels 40 in the same CCMD group). The resolution of a laser resolution grid 66 of the graph 30 can be 0.05 GHz, 0.1 GHz, etc., although this can be an approximation of 0.5 GHz, 1 GHz, etc., respectively, for efficiency. The resolution refers to how a channel 40 (NMC) can be centered on the graph 30, i.e., the center frequency of a laser associated with the channel 40. Also, a wavelength selective switch (WSS) edge pixelation frequency 56 can be 6.25 GHz, and the pixelation 56 refers to the discrete, stepped spectral boundaries of routed channels caused by the finite resolution of the WSS.

While channels 40 scheduled on a link must respect several constraints, there are a great many viable channel plans which may be explored in order to select the plan with the maximum total capacity; however, simply listing every possible channel plan would be too large to contain in memory, and simply traversing each option iteratively would take too long. Thus, it is challenging to identify a channel plan which achieves the true global maximal of the total capacity.

Conventionally, there are a couple of example greedy approaches attempted:
(1) Greedy Heuristic: from left-to-right select to schedule the channel with the maximal spectral efficiency, or the maximal bit rate, packing them as closely together as allowed by the guard and dead bands, and maximally filling out each CCMD.
(2) Greedy Global: iteratively schedules the channel with the overall globally maximal spectral efficiency, regardless of its position so long as it respects the rule of no overlapping channels, as well as an extra allowance of the dead band. Then, from left-to-right, assign consecutive channels to the same CCMD until it is filled, and then move onto the next CCMD.
(3) Additionally, there is the Monte-Carlo algorithm; however, the Greedy Heuristic seemed to outperform it in many testing cases.

The Greedy Global approach often generates suboptimal solutions, performing significantly worse than both the Monte-Carlo and Greedy Squeeze methods. It leaves a considerable amount of bandwidth unused. Even when special heuristics are applied to account for the shape of the ESNR curve (whether flat or sloped) within a given frequency range, the performance remains inadequate for practical use. As a result, Greedy Global is only used as a minimal baseline for comparison. While the Greedy Heuristic method also produces suboptimal solutions, its primary limitation is its inability to effectively handle the constraint of a limited number of available CCMDs. This lack of adaptability reduces its effectiveness in constrained environments. The Monte-Carlo method, despite also generating suboptimal solutions, struggles to scale effectively. Even when given more time, it fails to produce significantly better results. Moreover, since the solutions are derived through a stochastic (random) process, the methodology behind the outcomes is not easily transparent or interpretable.

Accordingly, the present disclosure provides a provably optimal solution to packing the graph 30 using DP. Dynamic programming is an algorithmic technique used to solve complex problems by breaking them down into simpler, overlapping subproblems. Instead of solving the same subproblem multiple times, dynamic programming stores the results of subproblems in a table or solves them in a bottom-up manner, thereby making a trade-off of storage space for reduced repeated computations. This process of storing results to be referenced later without recompilation is known as “memoization”. This approach is particularly effective for optimization problems where the solution to a larger problem depends on the solutions of its smaller components, such as in shortest path, knapsack, or sequence alignment problems. By solving each subproblem only once and storing its result, dynamic programming ensures that the overall solution is computed efficiently. Dynamic programming is often used to find optimal solutions because it explores all possible ways to combine subproblem solutions and chooses the combination that maximizes or minimizes a given objective, ensuring that the best (optimal) solution is found. However, this method may be quite spatially expensive, as it requires the storage of possibly many subproblems. Additionally, while DP makes a trade-off of storage space in order to reduce the runtime to something tractable, it may still be quite computationally expensive as it involves solving many subproblems, each of which may depend on multiple other subproblems. In cases where the problem has a large number of states or choices (for example, in high-dimensional spaces or long sequences), the memory and time required to store and compute all the possible solutions can grow exponentially, making dynamic programming resource-intensive for large-scale problems. In this particular application of DP, the computational complexity is exacerbated by the resolution of the laser frequency grid 66; each order of magnitude of finer frequency results in an order of magnitude longer runtime, due to the order of magnitude increase in the number of nodes in the graph. Increasing the band range would also result in an increase in size to the frequency grid, and therefore the number of nodes in the graph, but this would be a linear increase, rather than an exponential one. Additionally, this is to an extent true of the WSS edge pixelization resolution 56, and the CCMD 54 size as well, but these are unlikely to change by entire orders of magnitude, and therefore would have a more linear impact on increasing the graph size. Similarly, an increase in resolution of the baud rates or bit rates would result in an order of magnitude more edges in the graph.

The present disclosure includes a DP algorithm along with a novel encoding technique to store all possible solutions in a compact form in a graph. Finding the solution becomes a simple graph traversal. That is, the DP algorithm efficiently encodes all possible solutions by overlapping shared parts, allowing it to effectively search the solution space to find the channel plan with maximum total capacity. The plan identified using DP is provably optimal. This means that, with a DP algorithm, we can transmit more traffic using the same or fewer modems. This approach is particularly valuable for submarine channel plans, where laying cables is far more physically demanding than in terrestrial networks. In such cases, optimizing the channel plan is especially beneficial, even if it requires more time for planning and implementing complex solutions.

The following is a description of the precise details of the variables and constraints which define the channel planning problem, which are visualized in the graph 30. The variables which describe the problem space are:
(1) A frequency band, specified by a red edge 62 and a blue edge 64 (e.g., C-Band)
(2) A laser frequency resolution, which defines a laser frequency resolution grid 66
(3) The set of viable baud rates which are supported
(4) The set of viable bit rates which are supported
(5) An ReSNR function, a lookup table on the baud rates and bit rates which are supported, e.g., see the graph 50
(6) An ESNR curve, i.e., the curve 32, a function over the frequency band
(7) An ESNR margin; either a constant, or a function of frequency
(8) Guard band 60, which defines the margins between channels in the same CCMD group
(9) Dead band 58, which defines the margins between the edge of the CCMD and the MC
(10) The size(s) of the CCMDs (e.g., either 12 or 16)
(11) The number of CCMDs of each particular size
(12) The WSS pixelization frequency 56 for the edges of the MCs
With which we may specify the following constraints, that the channels must be scheduled such that:
(A) The frequencies that the channels occupy are within the frequency band
(B) The frequencies that the channels occupy do not overlap with each other
(C) Channel bandwidths must snap on the frequency grid (typically in the center of the channel, but may optionally be at either the left or the right)
(D) The ReSNR of a channel scheduled over a given frequency range is no greater than the ESNR for any frequency within a channel's occupied frequency range.
(E) Additionally, if an ESNR margin is specified, ReSNR <ESNR - ESNR_margin
(F) Channels within the same CCMD group must be scheduled contiguously on the frequency band
(G) Channels within the same CCMD group must respect a minimum margin of the guard band
(H) Dead band margin between CCMD and MC edges
(I) MC channel edges snap to a multiple of a the given “WSS pixelization frequency 56”

Variables (1)-(6) and constraints (A)-(D) are the minimum basis for formulating the problem; the other constraints are optional. The DP solution can handle both the minimum basis of the problem, as well as all combinations of optional constraints.

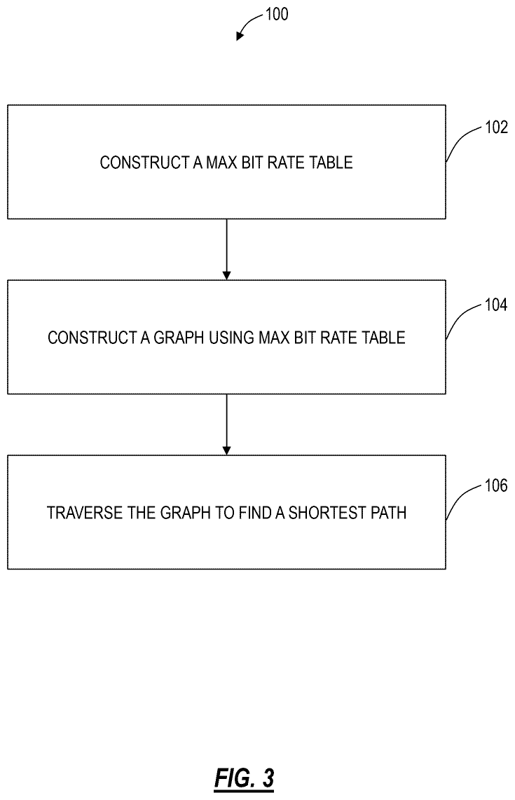

FIG. 3 illustrates a flowchart of a DP process 100 for determining the maximum capacity. The DP process 100 is built up in three phases: first, a max bit rate table is constructed using the provided ESNR curve 32 (and optionally ESNR margin curve 34) and the ReSNR lookup table (step 102); second, that max bit rate table is used to construct a graph, where each edge represents a choice to schedule or skip scheduling a channel for a given frequency and CCMD group or port (step 104); and lastly, the shortest path is found using a shortest-path algorithm which is capable of handling negative-weighted edges in a DAG, such as the Bellman-Ford algorithm (step 106).

That is, the DP process 100 provides a unique encoding approach to encode every possible solution compactly (whether optimal or not) as all possible st-paths within a graph, the DP process 100 is able to find the provably optimal solution, making the best use of all the bandwidth available. In a graph, st-paths refer to paths between two specific vertices, denoted as s (starting vertex (source)) and t (ending vertex (target)). The st-path is a sequence of edges that connect vertex s to t, such that the path follows the edges of the graph without revisiting any vertex more than once (in the case of a simple path), which is a given for free in a DAG, since no cycles exist and therefore any sequence of connected edges can never return to an earlier vertex.

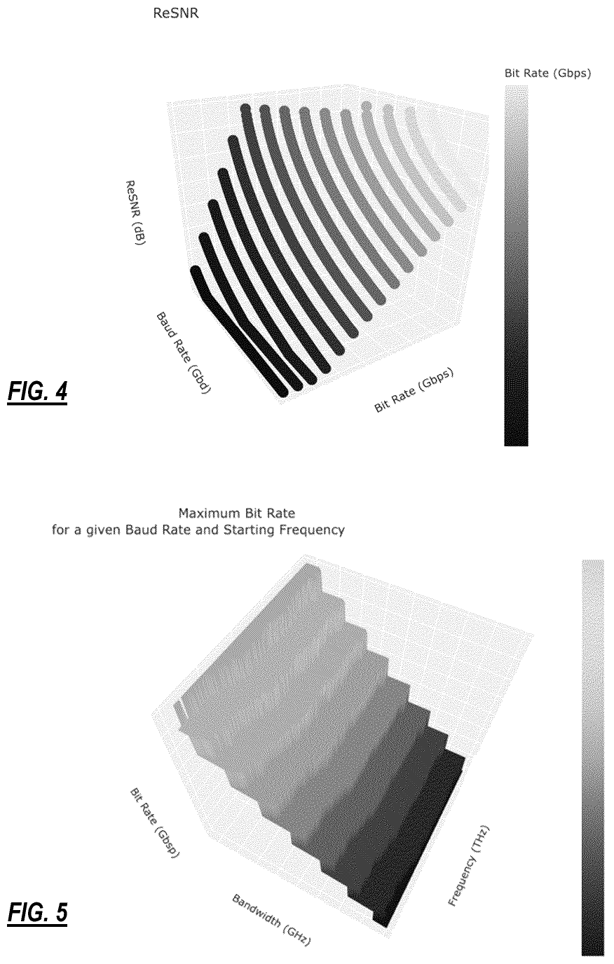

For the step 102, for a given ESNR curve 32, its max bit rate table will, for any given frequency f and baud rate b, return the bit rate such that the eSNR would satisfy the constraint of being greater than the ReSNR for the entire width of the occupied frequency between, for example, f-MSO(b)/2 and f+MSO(b)/2, if channel bandwidths must snap on the frequency grid at the center of the channel, f and f+MSO(b) if snapping on the left, and f-MSO(b) and f if snapping on the right, i.e., the rectangle of the channel 40, while maximizing the bit rate. An example of the constructed max bit rate table is given in FIGS. 4-5. FIG. 4 is a graph of ReSNR, which can be used with the ESNR curve 32, 34, to provide a resulting max bit rate table as illustrated in the graph in FIG. 5.

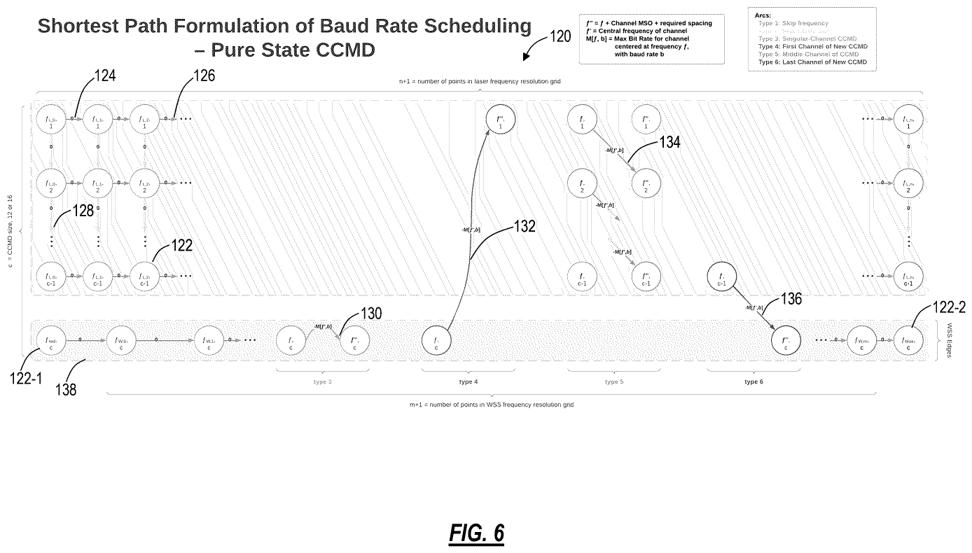

FIG. 6 illustrates a solution graph 120 encoding the solution space for the DP process 100. The solution graph 120 is constructed from the max bit rate table, the x-axis represents the frequency, the nodes on the y-axis represent a counter for the number of ports used to date in the current CCMD, and associated edges encode every possible channel from the max bit rate table, including trivial solutions such as where no channels are scheduled. The arcs are just representative of individual channels under consideration; it is an st-path from node s=(f_{red}, c) 122-1 to node t=(f_{blue}, c) 122-2 through the graph which then corresponds to a whole channel plan, a series of viable channels which can coexist simultaneously. This is the reason why the DP process 100 can provably select the best channel plan, because all solutions are certain to be encoded in the graph. The traversal of the solution graph 120 to find the optimal solution is determined based on the shortest st-path from node s=(f_{red}, c) 122-1 to node t=(f_{blue}, c) 122-2 in the solution graph 120.

Note that a shortest st-path in this graph corresponds to minimizing a sum of edge weights, which were set to the negative capacity of the corresponding channel placed in that position; therefore, minimizing these sums of edge weights is equivalent to maximizing the sums of the corresponding channel capacities. Alternatively, were the edges weighted with the capacity directly, without flipping it to negative, this might well have been thought of as a longest st-path algorithm, but the shortest st-path modality was used as it is the more common standard for path-optimization algorithms. It is also of particular importance that the graph be a DAG in the case of negative-weighted edges and shortest-path algorithms, in order to ensure no negative loops exist which could be exploited to achieve infinitely-shorter paths.

In particular, Bellman-Ford was selected because it is a shortest-path algorithm which supports negative-weighted edges in DAGs. Of note, the DP process 100 does not have to go through every single channel plan in order to find an optimal one, as shortest-path algorithms need not examine every possible path in order to determine a shortest one. It is this compact graph encoding and traversal which lends to the feasibility of this algorithm, the efficient examination of what would otherwise be too large a solution space.

The key to the present disclosure is the encoding of the solution graph 120 to allow the shortest path algorithm where all possible solutions are evaluated at once using DP. In the solution graph 120, vertices 122 represent, in combination, frequencies within the frequency band (i.e., the C-band) and ports on the multiplexer 22 (i.e., the CCMDs 54, e.g., c =12 or 16), and the edges 124 represent transitions for configuring the ports between given frequencies (the edges 124 can also be referred to as directed edges or arcs). The solution graph 120 includes (n+1)×(c-1)+(m+3) points, where (n+1) is the number of laser frequency grid points, c is the number of ports on the multiplexer 22, and (m+1) is the number of WSS pixelization frequency grid points. In the case where channel bandwidths must snap on the frequency grid at the center of the channel, f′ is the central frequency of a channel, f=f′-MSO(b)/2-spacing, and f″=f′+MSO(b)/2+spacing, where spacing might be the guard band, or deadband and any additional rounding, depending on whether the channel is a first, middle, last, or singular channel within its CCMD group, and M[f, b] is the maximum bit rate for a channel typically centered at frequency f with baud rate b, as derived from the max bit rate table.

The network itself is a representation of a DP: each node within the architecture represents a possible state of the DP; each edge 124 represents a viable transition between states of the DP, with a (negative) weight equal to the gained capacity should this transition be employed. An st-path within the architecture represents a valid schedule of channels; a shortest st-path then represents not only a valid schedule of channels, but the one with the highest capacity.

There are six types of arcs in the solution graph 120. An arc (also called a directed edge) is a connection or link between two vertices (nodes) that has a specific direction.
(1) A first type of arc 126 is to skip a frequency - these edges have zero weight and transition from one node to the next on the right.
(2) A second type of arc 128 that skips a CCMD port. For example, 2 CCMD-16 (32 ports for 32 channels) can cover the entire C-band. In fact, the C-Band may be covered with less than 32 channels, e.g., 24 channels—so there are cases where not every port on the CCMD are used. For example, it might be possible to achieve a higher capacity using a channel plan with less channels where each of the channels are wider, rather than a channel plan with more channels where the channels are narrower, thus possibly resulting in more optimal channel plans where less CCMD ports are needed.
(3) A third type of arc 130 for a singular channel CCMD. This is a trivial case where there is a single channel on the entire CCMD. This is unlikely to come up in real scenarios, but is included for completeness of the solution space. It requires special consideration due to the spacing of deadband which must be ensured between both to the left and right of the channel and the respective edges of the WSS window, as well as ensuring the WSS pixelization is respected by rounding down or up to the nearest WSS pixelization frequency for the left or right WSS edges, respectively.
(4) A fourth type of arc 132 for a first channel of a new CCMD. This is a special case requiring consideration for not only including the typical half quantity of the guard band as the spacing specifically to the right of the channel, but specially including a dead band between the left edge of the channel and the left WSS edge as well as ensuring the WSS pixelization is respected by rounding down to the nearest WSS pixelization frequency 56.
(5) A fifth type of arc 134 for a middle channel of a CCMD. This is a simple case requiring only consideration of a half quantity of the guard band as the spacing to either side of the channel.
(6) A sixth type of arc 136 for a last channel of a new CCMD. This is a special case requiring consideration for not only including the typical half quantity of the guard band as the spacing specifically to the left of the channel, but specially including a dead band between the right edge of the channel and the right WSS edge as well as ensuring the WSS pixelization is respected by rounding up to the nearest WSS pixelization frequency 56.

The arc 132 represents scheduling a new channel on a CCMD. After that, the arcs 134, 136 only go down by one to schedule a middle or last channel on the CCMD. A bottom row 138 has a possibly different number of points than the other rows as it represents the WSS edge pixelization frequency 56, which may be independent of the laser resolution grid frequency 66 (e.g., 6.25 GHz instead of 0.1 GHz). Note, the first and last channel are special because they need to take into consideration the pixelization frequency 56 of the WSS window edges for the media channel. An empty schedule would just traverse the row 138 from left to right (no channels). Of note, the CCMD 54 or multiplexer 22 typically has (but not necessarily) a much finer granularity than the WSS, and the row 138 enables snapping the WSS window edges to the WSS granularity. The nodes on the row 138 snap to the WSS granularity.

The arc 130 represents a single channeled CCMD, where the channel can be considered simultaneously both the first and last channel, while the arc 132 represents a first channel in a new CCMD, and the arc 136 represents the last channel of the CCMD; in each of these cases, special considerations must be made for the sides of the channels which are closest to a WSS edge (both sides, in the case of the singular channel) to ensure that the space not only accounts for the deadband, but additionally for any additional spectrum required for the WSS edge to snap to the WSS pixelization resolution grid, represented by row 138.

M is your maximum bit rate table, and you recall there are two things that you use to look up within the maximum bit rate table. It's a frequency and baud. So, with the maximum bit rate table, you look up the center frequency f′ (alternatively, the table could be built according to the left or right frequency) and a baud b, where the left and right edge of the channel will be f'-MSO(b) and f′+MSO(b), respectively. Then f and f′ will be the left and right frequencies of the corresponding arc for such a potential channel, additionally incorporating not only half the width of the channel to each side, but also any space which is considered to ‘belong’ to that channel, namely any guard band (half to each side), dead band (the full quantity on any outer channel frequencies) and any additional rounding caused by enforcing the WSS edge snapping. With the baud rate and center frequency, the maximum bit rate table gives the maximum bit rate for the potential channel, which will in turn be the negative weight for the corresponding edge.

The edges 124 all move to the straight to the right, straight down, diagonally down-right, or diagonally up-right - there is no possibility of a loop in the graph, i.e., it is a DAG so using a shortest path algorithm (with negative weights) will give the optimal solution.

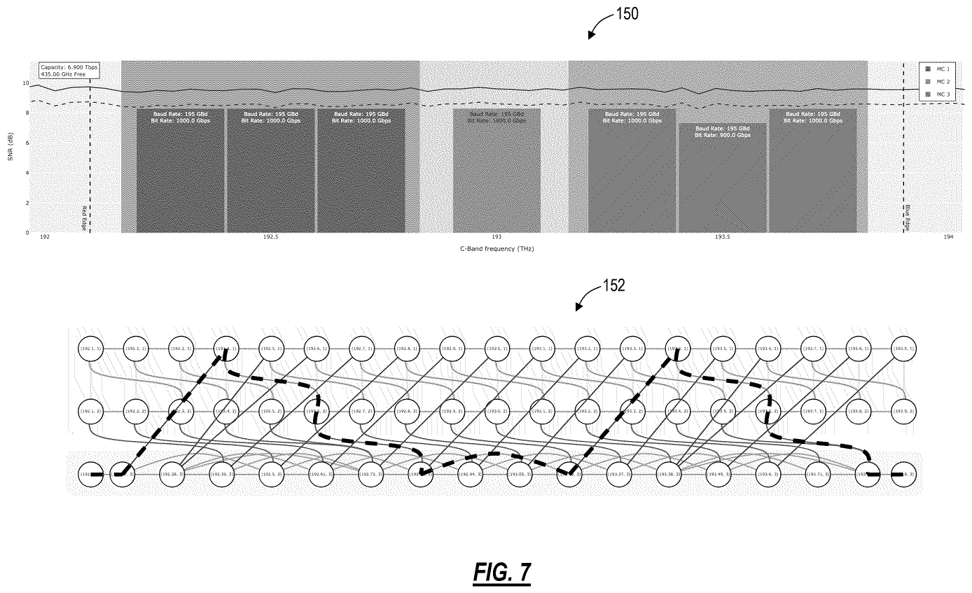

FIG. 7 illustrates an example operation with a graph 150 illustrating optical spectrum and associated channels based on traversal of a graph 152.

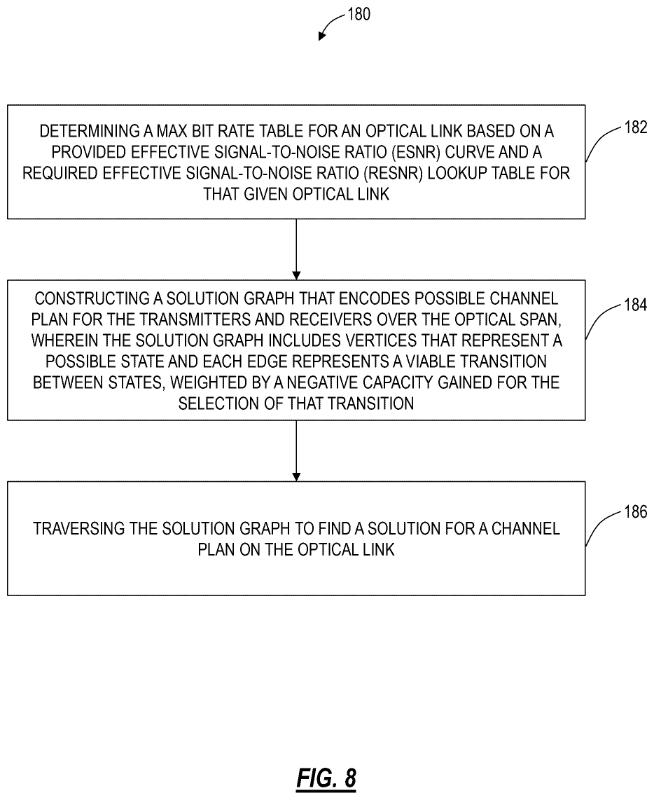

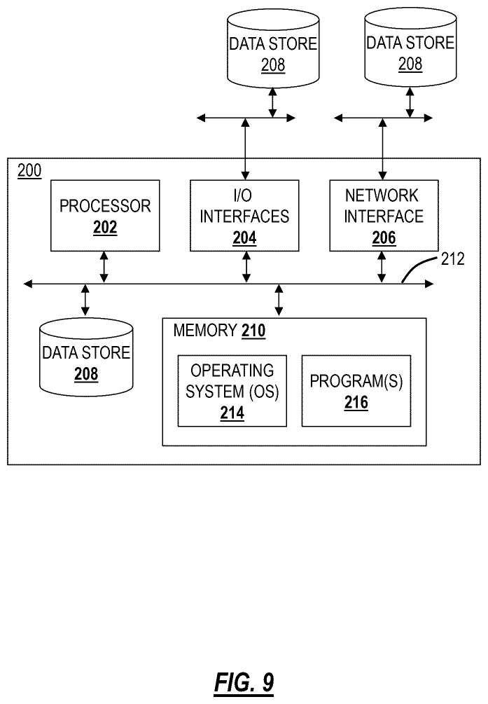

FIG. 8 illustrates a flowchart of a process 180 for dynamic programming using a shortest-path solution over a DAG for channel planning with select transmission modes in an optical link. The process 180 contemplates implementation as a method having steps, via an apparatus such as the processing system 200 in FIG. 9 configured to implement the steps, and as a non-transitory computer-readable medium storing instructions that, when executed, cause one or more processors to implement the steps.

The steps include determining a max bit rate table for an optical link based on a provided effective signal-to-noise ratio (ESNR) curve and a Required Effective Signal-to-Noise Ratio (ReSNR) lookup table for that given optical link (step 182); constructing a solution graph that encodes possible channel plans for the transmitters and receivers over the optical span, wherein the solution graph includes vertices that represent a possible state and each edge represents a viable transition between states, weighted by a negative capacity gained for the selection of that transition (step 184); and traversing the solution graph to find a solution for a channel plan on the optical link (step 186).

The traversing can include finding a shortest path through the solution graph where edges have a negative weight. The traversing can utilize the Bellman-Ford algorithm. The max bit rate table, for the provided ESNR curve and ReSNR table, and any given frequency f and baud rate b, returns the maximum bit rate such that the ESNR satisfies a constraint of being greater than ReSNR. Determining the max bit rate table can further include subtracting an ESNR margin from the ESNR curve.

The solution graph includes a plurality of vertices, each representing a state of the channel plan, and the solution graph includes an x-axis for frequency, each vertex spaced at a resolution of the optical spectrum, and y-axis for ports on multiplexers. The traversing moves left to right to determine the channel plan with a plurality of possible arcs. A last row of the plurality of vertices can be spaced apart based on wavelength selective switch (WSS) resolution, and other rows of the plurality of vertices are spaced apart based on a configured resolution which is independent from the WSS resolution. Arcs in the graph which are corresponding to a first and a last channel in the channel plan snap to the WSS resolution in the last row, ensuring that the WSS edges are correctly divisible by the WSS pixelization frequency.

FIG. 9 illustrates a block diagram of a processing system 200, which can be used to implement a network management system, planning system, controller, or similar functions. Multiple processing systems 200 can also be grouped into a cluster or other resource group to implement the processes 100, 180, such as a Software-as-a-Service (SaaS) solution in the cloud. The processing system 200 is a digital computer that typically includes a processor 202, input/output (I/O) interfaces 204, a network interface 206, a data store 208, and memory 210. Note that FIG. 9 presents a simplified version of the processing system, and practical embodiments may include additional components and logic to support known operational features not described here. The components (202, 204, 206, 208, and 210) are connected via a local interface 212, which could be a bus or other wired or wireless connections, as known in the field. The local interface 212 may also include other elements like controllers, buffers, drivers, and receivers to support communication among components. It may also handle address, control, and data connections for proper communication.

The processor 202 is a hardware device designed to execute software instructions. It may be any type of processor, including a custom-made or commercially available Central Processing Unit (CPU), an auxiliary processor, a semiconductor microprocessor (such as a microchip or chipset), or other devices capable of running software. When the processing system 200 is active, the processor 202 executes software stored in the memory 210, manages data communication with the memory, and controls the overall operations of the system based on the software. The I/O interfaces 204 handle input from and output to external devices or components.

The network interface 206 enables the processing system 200 to communicate over a network, supporting address, control, and data connections. The data store 208 stores data and may include volatile memory (e.g., random access memory (RAM) such as DRAM, SRAM, SDRAM) and nonvolatile memory (e.g., ROM, hard drives, tape, CDROM), as well as combinations of these. It may use electronic, magnetic, optical, or other storage media. The data store 208 can be internal to the system (e.g., an internal hard drive connected to the local interface 212) or external (e.g., an external hard drive connected via the I/O interfaces 204). It could also be part of a network, such as a network-attached file server.

The memory 210 can include both volatile and nonvolatile memory elements (e.g., RAM, ROM, hard drive, tape, CDROM) and may be electronic, magnetic, optical, or another type of storage media. The memory 210 may be distributed, with components located remotely but accessible by the processor 202. It stores software, which includes an Operating System (O/S) 214 and one or more programs 216. The O/S 214 manages the execution of programs 216 like the one(s), providing scheduling, input/output control, file management, memory management, and communication control. The program(s) 216 are designed to implement the processes, algorithms, methods, and techniques described in this disclosure.

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A non-transitory computer-readable medium storing instructions that, when executed, cause one or more processors to implement steps of:
determining a max bit rate table for an optical link based on a provided effective signal-to-noise ratio (ESNR) curve and a Required Effective Signal-to-Noise Ratio (ReSNR) lookup table for that given optical link;
constructing a solution graph that encodes possible channel plans for the transmitters and receivers over the optical span, wherein the solution graph includes vertices that represent a possible state and each edge represents a viable transition between states, weighted by a negative capacity gained for the selection of that transition, for dynamic programming; and
traversing the solution graph to find a solution for a channel plan on the optical link.

2. The non-transitory computer-readable medium of claim 1, wherein the traversing includes finding one of a shortest st-path through the solution graph which represents a channel plan with maximal capacity.

3. The non-transitory computer-readable medium of claim 1, wherein the traversing includes finding a shortest st-path through the solution graph where edges have a negative weight.

4. The non-transitory computer-readable medium of claim 3, wherein the traversing utilizes Bellman-Ford algorithm.

5. The non-transitory computer-readable medium of claim 1, wherein the max bit rate table, for the provided ESNR curve and ReSNR table, and any given frequency f and baud rate b, returns the maximum bit rate such that ESNR satisfies a constraint of being greater than ReSNR.

6. The non-transitory computer-readable medium of claim 1, wherein the determining the max bit rate table further includes subtracting an ESNR margin from the ESNR curve.

7. The non-transitory computer-readable medium of claim 1, wherein the solution graph includes a plurality of vertices, each representing a state of the channel plan, and the solution graph includes an x-axis for frequency, each vertex spaced at a resolution of optical spectrum, and y-axis for ports on multiplexers.

8. The non-transitory computer-readable medium of claim 7, wherein the traversing moves left to right to determine the channel plan with a plurality of possible arcs.

9. The non-transitory computer-readable medium of claim 7, wherein a last row of the plurality of vertices is spaced apart based on wavelength selective switch (WSS) resolution, and other rows of the plurality of vertices are spaced apart based on a configured laser resolution which is independent of the WSS resolution.

10. The non-transitory computer-readable medium of claim 9, wherein WSS edges align to the WSS resolution in the last row.

11. A method comprising steps of:
determining a max bit rate table for an optical link based on a provided effective signal-to-noise ratio (ESNR) curve and a Required Effective Signal-to-Noise Ratio (ReSNR) lookup table for that given optical link;
constructing a solution graph that encodes possible channel plans for the transmitters and receivers over the optical span, wherein the solution graph includes vertices that represent a possible state and each edge represents a viable transition between states, weighted by a negative capacity gained for the selection of that transition; and
traversing the solution graph to find a solution for a channel plan on the optical link.

12. The method of claim 11, wherein the traversing includes finding one of a shortest path through the solution graph which represents a channel plan with maximal capacity.

13. The method of claim 11, wherein the traversing includes finding a shortest path through the solution graph where edges have a negative weight.

14. The method of claim 13, wherein the traversing utilizes Bellman-Ford algorithm.

15. The method of claim 11, wherein the max bit rate table, for the provided ESNR curve and ReSNR table, and any given frequency f and baud rate b, returns the maximum bit rate such that ESNR satisfies a constraint of being greater than ReSNR.

16. The method of claim 11, wherein the determining the max bit rate table further includes subtracting an ESNR margin from the ESNR curve.

17. The method of claim 11, wherein the solution graph includes a plurality of vertices, each representing a state of the channel plan, and the solution graph includes an x-axis for frequency, each vertex spaced at a resolution of optical spectrum, and y-axis for ports on multiplexers.

18. The method of claim 17, wherein the traversing moves left to right to determine the channel plan with a plurality of possible arcs.

19. The method of claim 17, wherein a last row of the plurality of vertices is spaced apart based on wavelength selective switch (WSS) resolution, and other rows of the plurality of vertices are spaced apart based on a configured resolution which is independent of the WSS resolution.

20. The method of claim 19, wherein WSS edges align to the WSS resolution in the last row.
